(19) United States
(12) Patent Application Publication
(10) Pub. No.: US 2007/0174831 A1
(43) Pub. Date: Jul. 26, 2007

(54) SYSTEM AND METHOD FOR DISTRIBUTING FILE PROCESSING TASKS

(75) Inventors: CHUNG-I LEE, Tu-Cheng (TW); CHIEN-FA YEH, Tu-Cheng (TW); XIAO-PING ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,796

(22) Filed: Sep. 28, 2006

(30) Foreign Application Priority Data
Jan. 20, 2006 (TW) 095102363

(51) Int. Cl. G06F 9/445

(52) U.S. Cl. 717/174

(57) ABSTRACT

An exemplary distribution system includes a plurality of file processing servers (20) and a file processing control server (10). The file processing servers are configured for processing distributed file processing tasks. The file processing control server includes a request receiving module (101), a status controlling module (102), a load checking module (103) and an allocating module (104). The request receiving module is configured for receiving file processing requests for file processing, and transforming the file processing requests into file processing tasks respectively. The status controlling module is configured for controlling statuses of the file processing tasks. The load checking module is configured for checking the load of each file processing server. The allocating module is configured for allocating a file processing task to a file processing server having the least load.

### FIELD OF THE INVENTION

The present invention is generally related to systems and methods on data processing, and more particularly, to a system and method for distributing file processing tasks.

### DESCRIPTION OF RELATED ART

Computers has become important in assisting people either in everyday life or during work. One common and important function of a computer is file processing, such as generating text reports, transforming file formats, printing files, and the like. For an individual, a single typical personal computer is more than enough to process various files for the individual. As the amount of file processing tasks increases, such as in a multi-person company, one computer may not finish all the processing tasks in time. Some multi-person companies use a server that has much better performances than a typical personal computer to process the file processing tasks. An employee uses a client computer to request the server to process file processing tasks. However, this client-server structure can only be applied in relatively small to medium sized companies that do not process a large amount of file processing tasks daily.

In a large sized company, this simple client-server mode may not afford a heavy loading of file processing. In order to satisfy the demand or heavy loading of file processing, the large company may require more than one file processing server to process large amount of file processing requests for file processing from either employees or customers of the company in time.

What is needed, therefore, is a system and method for file processing distribution that manages and distributes file processing tasks to a plurality of file processing servers efficiently and timely.

### SUMMARY OF THE INVENTION

One preferred embodiment provides a distribution system for file processing. The distribution system includes a plurality of file processing servers and a file processing control server. The plurality of file processing servers is configured for processing distributed file processing tasks. The file processing control server includes a request receiving module, a status controlling module, a load checking module and an allocating module. The request receiving module is configured for receiving file processing requests for file processing each of which is assigned with a unique identification, and transforming the file processing requests into file processing tasks respectively. The status controlling module is configured for controlling statuses of the file processing tasks. The load checking module is configured for checking the load of each file processing server. The allocating module is configured for allocating a file processing task to be processed to the file processing server having the least load.

Another preferred embodiment provides a computer-based method for distributing file processing tasks. The method includes the steps of: providing a plurality of file processing servers for processing distributed file processing tasks; receiving a file processing request assigned with a unique identification, and transforming the file processing request into a file processing task inheriting the identification of the file processing request; adding the file processing task into a ready queue; checking the load of each of the file processing servers; allocating the file processing task in the ready queue to the file processing server having the least load; and processing the file processing task by the file processing server.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of a hardware configuration of a distribution system for file processing tasks in accordance with one preferred embodiment;

FIG. 2 is a schematic diagram of function modules of a file processing control server of FIG. 1; and

FIG. 3 is a flowchart of a method for distributing file processing tasks in accordance with one preferred embodiment.

### DETAILED DESCRIPTION OF THE INVENTION

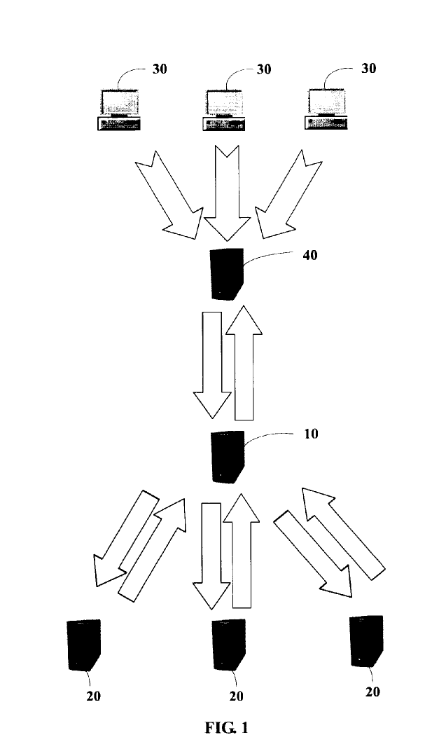

FIG. 1 is a schematic diagram of a hardware configuration of a distribution system for file processing tasks in accordance with one preferred embodiment. The distribution system typically includes a file processing control server 10, a plurality of file processing servers 20, a business system server 40, and a plurality of client computers 30. The client computers 30 are connected to the business system server 40. The business system server 40 is connected to the file processing control server 10 that is further connected to the file processing servers 20.

The client computers 30 are configured for users sending file processing requests to the business system server 40, the business system server 40 then transmits the file processing requests to the file processing control server 10. For example, such file processing requests may be requests for printing files. In an alternative embodiment, the client computers 30 may send the file processing requests directly to the file processing control server 10.

The file processing control server 10 is configured for receiving the file processing requests from the business system server 40 or the client computers 30, for transforming the file processing requests into file processing tasks, for allocating the file processing tasks to the file processing servers 20 for processing, and for returning a status of each file processing task to the client computer 30 that sent the corresponding file processing request. Each file processing request is assigned with a unique identification by the file processing control server 10 once received, and the corresponding file processing task transformed therefrom inherits the identification. The file processing control server 10 is further configured for checking the load of each of the file processing servers 20 in real time in order to allocate a file processing task to a file processing server 20 having the least load.

The file processing servers 20 are configured for processing the file processing tasks distributed by the file processing control server 10. Each file processing server 20 may include a processing queue recording unfinished file processing tasks allocated thereto.

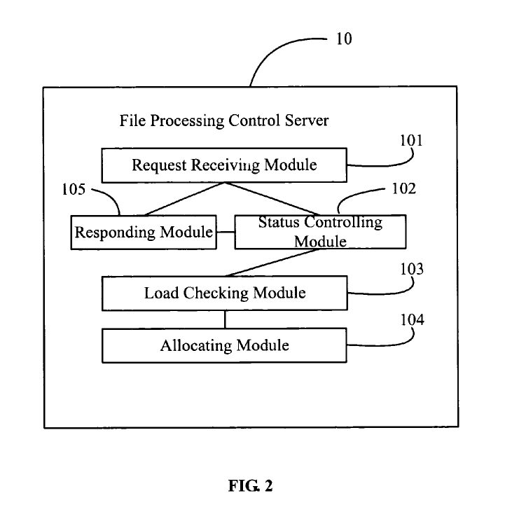

FIG. 2 is a schematic diagram of function modules of the file processing control server 10. Specifically, the file processing control server 10 includes a request receiving module 101, a status controlling module 102, a load checking module 103, an allocating module 104, and a responding module 105.

The request receiving module 101 is configured for receiving file processing requests from the business system server 40 or the client computers 30, and for transforming the file processing requests into file processing tasks respectively. Each file processing request corresponds to a file processing task that can be processed by either of the file processing servers 20. Each file processing request is assigned with a unique identification by the request receiving module 101 once received, and the corresponding file processing task transformed therefrom inherits the identification.

The status controlling module 102 is configured for controlling statuses of the file processing tasks. The status controlling module 102 is further configured for creating a ready queue for recording file processing tasks ready to be allocated to the file processing server 10, and for creating a finish queue for recording file processing tasks being finished. Both the ready queue and the finish queue are a first-in, first-out (FIFO) queue. Specifically, the status controlling module 102 adds a file processing task into a processing queue of a selected file processing server 20 and deletes the file processing task from the ready queue if the file processing task is allocated to the selected file processing server 20. Furthermore, if the file processing task is finished by the selected file processing server 20, the status controlling module 102 adds the file processing task into the finish queue and deletes the file processing task from the processing queue of the selected file processing server 20.

The load checking module 103 is configured for checking the load of each file processing server 20 in real time if there is a file processing task in the ready queue. The load of the file processing server 20 is a product of an average processing time for a file processing task and a total number of file processing tasks in the processing queue of the file processing server 20. The allocating module 104 is configured for allocating the file processing task in the ready queue to a file processing server 20 having the least load of the file processing servers 20.

The responding module 105 is configured for returning statuses of the file processing tasks to the business system server 40 or the client computers 30. The statuses of a file processing task corresponding to the file processing request from the business system server 40 or the client computers 30 may be a ready status, a processing status, or a finish status, in which the ready status means that the file processing task is in the ready queue waiting for allocation, the processing status means that the file processing task is in a processing queue of a file processing server 20, and the finish status means that the file processing task is finished by one of the file processing servers 20 and currently in the finish queue.

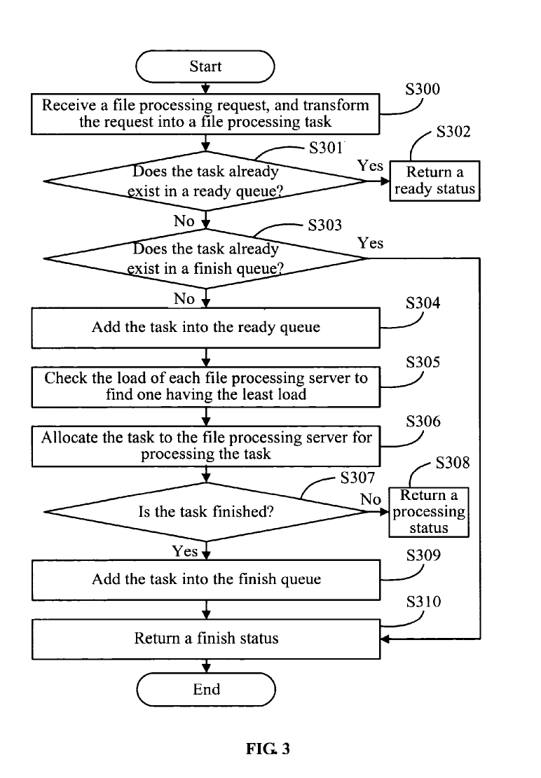

FIG. 3 is a flowchart of a method for distributing file processing tasks in accordance with one preferred embodiment. The method is achieved by utilizing the distribution system introduced above. The detail of the method are described below step by step.

In step S300, the task receiving module 101 receives a file processing request from the business system server 40 or one of the client computers 30, assigns the file processing request with a unique identification, and transforms the file processing request into a file processing task inheriting the identification of the file processing request.

In step S301, the status controlling module 102 determines whether the file processing task already exists in the ready queue. If the file processing task already exists in the ready queue, in step S302 the responding module 105 returns a ready status in response to the file processing request from the business system server 40 or one of the client computers 30, finally to the corresponding user.

If the file processing task does not already exist in the ready task queue, in step S303 the status controlling module 102 determines whether the file processing task already exists in the finished queue. If the file processing task already exists in the finished queue, that is, the file processing task has finished processing, the procedure goes directly to step S310. In step S310, the responding module 105 returns a finish status in response to the file processing request from the business system server 40 or one of the client computers 30 correspondingly.

If the file processing task does not already exist in the finish queue, in step S304 the status controlling module 102 adds the file processing task into the ready queue. In step S305, the load checking module 103 checks the load of each file processing server 20 in order to find the file processing server 20 having the least load of the file processing servers 20. In step S306, the allocating module 104 allocates the file processing task to the file processing server 20 having the least load, the status controlling module 102 then adds the file processing task into a processing queue of the file processing server 20 and deletes the file processing task from the ready queue.

In step S307, the status controlling module 102 determines whether the file processing task is finished by the file processing server 20. If the file processing task is not finished, in step S308 the responding module 105 returns the processing status in response to the file processing request from the business system server 40 or one of the client computers 30 correspondingly. If the file processing task is finished, in step S309 the status controlling module 102 adds the file processing task into the finish queue, and delete the file processing task from the processing queue of the file processing server 20. In step S310, the responding module 106 returns the finish status in response to the file processing request from the business system server 40 or one of the client computers 30 correspondingly.

It should be noted that the above-described method can be used for processing a plurality of file processing requests for file processing. In processing more than one such file processing request, the method may further includes the step of: the task determining module 105 determining whether there is any file processing task existing in the ready task queue.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A distribution system for file processing tasks, the distribution system comprising:
a plurality of file processing servers configured for processing distributed file processing tasks; and
a file processing control server comprising:
a request receiving module configured for receiving file processing requests each being assigned with a unique identification, and transforming the file processing requests into file processing tasks inheriting corresponding identifications of the file processing requests respectively;
a status controlling module configured for controlling statuses of the file processing tasks;
a load checking module configured for checking the load of each of the file processing servers; and
an allocating module configured for allocating a file processing task to a file processing server having the least load.

2. The distribution system according to claim 1, wherein the file processing control server further comprises a responding module configured for returning statuses of the file processing tasks corresponding to the file processing requests respectively, the status being selected from the group consisting of a ready status, a processing status, and a finish status.

3. The distribution system according to claim 1, wherein the status controlling module is further configured for creating a ready queue for recording file processing tasks ready to be allocated to a file processing server, and creating a finish queue for recording file processing tasks being finished.

4. The distribution system according to claim 1, wherein each of the file processing server comprises a processing queue for recording unfinished file processing tasks allocated to the file processing server.

5. The distribution system according to claim 4, wherein the load of a file processing server is a product of an average processing time for a file processing task and a total number of file processing tasks in the processing queue of the file processing server.

6. A computer-based method for distributing file processing tasks, the method comprising:
providing a plurality of file processing servers for processing distributed file processing tasks;
receiving a file processing request assigned with a unique identification, and transforming the file processing request into a file processing task inheriting the identification of the file processing request;
adding the file processing task into a ready queue;
checking the load of each of the file processing servers; and
allocating the file processing task in the ready queue to a file processing server having the least load.

7. The method according to claim 6, further comprising the step of:
adding the file processing task into a processing queue of the file processing server and deleting the file processing task from the ready queue if the file processing task is allocated to the file processing server.

8. The method according to claim 7, wherein the load of a file processing server is a product of an average processing time for a file processing task and a total number of file processing tasks in the processing queue of the file processing server.

9. The method according to claim 6, further comprising the step of:
processing the file processing task by the file processing server which is checked having the least load.

10. The method according to claim 6, further comprising the step of: adding the file processing task into a finish queue and deleting the file processing task from the processing queue if the file processing task is processed by the file processing server.

11. The method according to claim 6, further comprising the step of: returning a status of the file processing task, the status being selected from the group consisting of a ready status, a processing status, and a finish status.
